(19) United States
(12) Patent Application Publication
(10) Pub. No.: US 2004/0247865 A1
(43) Pub. Date: Dec. 9, 2004

(54) Electrolytic process for depositing a layer of copper on a steel wire

(76) Inventor: Federico Pavan, Firenze (IT)

Correspondence Address: FINNEGAN, HENDERSON, FARABOW, GARRETT & DUNNER, LLP, 1300 I STREET, NW, WASHINGTON, DC, 20005, US

(21) Appl. No.: 10/484,242

(22) PCT Filed: Jul. 11, 2002
(86) PCT No.: PCT/EP02/07750

Related U.S. Application Data
(60) Provisional application No. 60/324,264, filed on Sep. 25, 2001.

(30) Foreign Application Priority Data
Jul. 27, 2001 (EP) 01830501.1

(51) Int. Cl. C25D 7/06; C25D 3/38; B32B 19/00

(52) U.S. Cl. 428/357; 205/138; 428/457

(57) ABSTRACT

An electrolytic process for depositing copper on a steel wire in which the wire travels through an acidic electrolytic bath of an aqueous solution of Cu²⁺ ions in the form of a salt of an acid. A direct electric current passes through the solution between at least one anode and the wire acting as cathode. The bath also has from 1.9 to 6 mM/l of a thiourea and from 1.9 to 6 mM/l of an amino acid.

The present invention relates to an electrolytic process for depositing a layer of copper on a steel wire for use in the production of a brass-coated wire.

It is known that some articles of vulcanized elastomeric material, for example vehicle tyres, conveyor belts, drive belts and flexible hoses made of natural or synthetic rubber and their mixtures, are reinforced by embedding suitable metallic structures in an elastomeric matrix.

Generally said metallic structure is made of steel wires, having a carbon content between 0.6% and 0.95%, individual or grouped together as steel cords.

However, steel, which is the material of choice for its mechanical properties, has the disadvantage that it does not sufficiently adhere to the vulcanized elastomeric material and it is subject to corrosion.

To protect the steel wire from corrosion and to obtain good adhesion to the elastomeric material, usually the steel is coated with a layer of a suitable material, for example brass. In this case, adhesion is improved owing to the formation, during the vulcanization process, of disulphide bridges (-S-S-) between the elastomeric matrix and the copper that is a constituent of the brass.

In the present description and in the claims, the term “brass” indicates a metallic composition, as homogeneous as possible, consisting of 10-50 wt. % zinc and 90-50 wt. % copper, preferably from 20 to 40 wt. % of zinc and from 80 to 60 wt. % of copper and, even more preferably, from 30 to 40 wt. % of zinc and from 70 to 60 wt. % of copper.

In the present description and in the claims, the term “cord” means a cord obtained, according to traditional techniques, by stranding drawn steel wires covered with a layer of brass which, prior to drawing, has a thickness from 1 to 3 μm, whereas after drawing has a thickness from 0.1 to 0.4 μm. Generally, the diameter of said wires is about 0.70-3.50 mm before drawing and 0.10-0.90 mm after drawing. Typically, a cord commonly used for reinforcing structures of giant tyres is made up of 7 strands, each of 4 wires with diameter of about 0.175 mm, around which is wound a thinner wire, with diameter of 0.15 mm.

One of the techniques employed in the past for covering a steel wire with a layer of brass consisted of simultaneous electrodeposition of a predetermined quantity of copper ions and zinc ions to form a homogeneous layer of brass in situ. It was observed, however, that the adhesion of the layer of brass thus obtained to the elastomeric material was excellent at first, but gave no guarantees of maintaining acceptable levels of adhesiveness over time.

Nowadays the most common technique envisages electrodeposition, on a steel wire, of a layer of copper and of a layer of zinc in two separate stages, followed by a third stage of thermal diffusion obtained by heating the wire, by the Joule effect or by induction, for about 5-10 seconds at a temperature above 450° C., preferably at a temperature from 450 to 500° C. During this stage the aforesaid layers diffuse into one another forming a layer of brass, of alpha crystalline phase, cubic, face-centred, which has excellent characteristics of drawability and adhesiveness.

In said process, the electrodeposition of a layer of copper onto a steel wire envisages a first stage consisting of electrolytic pickling of the steel wire (Stage A in Example 1).

This stage of electrolytic pickling is followed by a second stage consisting of alkaline copper plating (Stage B′ in Comparative Example 1). Generally, the thickness of the layer of copper applied by means of said process is about 0.5 μm.

The electrodeposition of copper is then completed, until a copper layer of at least 1 μm is obtained, with a third stage consisting of acidic copper plating (Stage B″ in Comparative Example 1).

The reason why the first electrodeposition of copper has to be carried out in a basic environment is that during acidic copper plating of a steel wire, a phenomenon of “cementation” occurs, which is a reaction of corrosion and displacement in which the copper ions of the solution, being more noble than the iron in the wire, are reduced to metallic copper whereas the iron is oxidized to ferrous ion and goes into solution.

The layer of copper that is deposited on the steel wire in this way has the disadvantage that it is powdery and has poor adhesion.

Furthermore, it has been found that the layer of copper deposited in an alkaline environment (basic copper plating) has the disadvantage that it impedes the diffusion of zinc during the previously mentioned stage of thermal diffusion, thus preventing the formation of a homogeneous layer of brass. The reasons for this phenomenon have not yet been fully elucidated. However, there is a theory according to which said phenomenon is due to the precipitation of basic salts in the copper layer.

Even though it has the aforementioned disadvantage, at present it is necessary to use basic copper plating to deposit a first layer of copper on the steel wire, to which said first layer adheres tenaciously and prevents the phenomenon of cementation during the subsequent acidic copper plating.

The results obtained with this technique are satisfactory but the need for two stages of copper plating, first in a basic bath and then in an acidic bath, greatly increases plant costs and process costs compared with what the costs might be if it-were possible to deposit all of the required layer of copper in a single acidic bath.

Therefore there have been many attempts to avoid the “cementation” process and so to allow electrolytic deposition of a layer of copper on a steel wire in an acidic bath without a prior stage of basic copper plating.

U.S. Pat. No. 5,431,803 describes a method for forming a continuous film of copper on a rotating cylindrical cathode of chromium-plated stainless steel, said method comprising (A) a flow of electrolytic solution between an anode and a cathode, and the application of an effective voltage between said anode and said cathode to deposit copper on said cathode; said electrolytic solution comprising copper ions, sulphate ions and at least one organic additive or one of its derivatives, the maximum concentration of chlorine ions of said solution being about 1 ppm; the current density being about 10-500 A/dm²; and (B) removal of the copper film from said cathode.

Said organic additive is preferably selected from the group comprising: saccharin, caffeine, molasses, guar gum, gum arabic, thiourea, polyalkylene glycols, dithiothreitol, amino acids, acrylamides, sulphopropyl disulphide, tetraethylthiuram disulphide, alkylene oxides,. sulphonates of sulphonium alkanes, thiocarbamoyl disulphides, their derivatives, or their mixtures. The quantity of said organic additive is 3-100 ppm.

Some variants of the aforesaid method are described in U.S. Pat. No. 5,403,465, but it does not give any indication regarding the chemical, nature of the cathode used, and in U.S. Pat. No. 5,454,926, in which the cathode is made of titanium.

As the cathode is made of metals (chromium or titanium) that are more noble than copper, the aforesaid organic additives do not have the purpose of preventing the phenomenon of cementation.

The inventors of the present invention have found that the acidic baths described in the aforementioned documents are not able to prevent the phenomenon of cementation when the cathode consists of a steel wire (Comparative Example 3).

However, they found, surprisingly, that the phenomenon of cementation is eliminated when copper is deposited on a steel wire from an acidic bath in which both a thiourea and an amino acid are simultaneously present in quantities substantially greater (at least 1.9 mM) than those envisaged by U.S. Pat. No. 5,431,803.

Accordingly, the present invention relates to an electrolytic process for depositing copper on a steel wire in which said wire travels through an acidic electrolytic bath comprising an aqueous solution of Cu²⁺ ions in the form of a salt of an acid, with a direct electric current passing through said solution between at least one anode and said wire that acts as cathode, characterized in that said bath also contains from 1.9 to 6 mM/l of a thiourea and from 2 to 6 mM/l of an amino acid.

Preferably, the quantity of said thiourea and of said amino acid is of from 3 to 5 mM.

Preferably, the thiourea of the present invention has the following general formula:

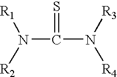

where

R₁ is hydrogen or methyl

R₂, R₃ and R⁴, the same or different, are hydrogen, alkyl with 1-4 carbon atoms, alkenyl with 2-4 carbon atoms, alkoxy with 1-3 carbon atoms, alkanoyl with 2-4 carbon atoms or phenyl.

Thiourea, monophenyl thiourea, monoallyl thiourea and monoacetyl thiourea are particularly preferred.

Thiourea is the most preferred.

Amino acids that are preferred according to the present invention are glycine, cysteine, alanine and methionine. Glycine is the most preferred.

Advantageously, the copper salt is copper sulphate. Preferably, the aqueous solution (electrolytic bath) of the present invention contains from 47 to 62 g/l, preferably from 52 to 57 g/l, of Cu²⁺.

Typically, the cathode current density is 20-40, preferably 25-35 A/dm².

Typically, the electrolytic bath is maintained at a temperature of 30-50° C., preferably of about 35-45° C.

The anodes can be soluble or insoluble. The soluble anodes consist of electrolytic copper and their progressive dissolution makes it possible to maintain the Cu²⁺ concentration in the electrolytic bath within the predetermined range.

The insoluble anodes consist of lead or of titanium coated with a varnish comprising iridium and tantalum in which the iridium acts as an anticorrosion agent while the tantalum acts as a binder. In this case the Cu²⁺ concentration is kept within the predetermined range by adding cupric oxide.

The bath pH is preferably maintained between 1 and 3 by adding sulphuric acid.

Compared with the traditional method in which copper plating in an acidic bath is preceded by copper plating in an alkaline bath (Comparative Example 1), the process of the present invention has the following advantages:

a) a saving of about 30% of the labour for operation and control of the brass coating process,

b) saving of the reagents used in the stage of electrodeposition of copper in the alkaline bath (copper pyrophosphate, potassium pyrophosphate and pyrophosphoric acid),

c) saving of about 5% of the energy required for the brass coating process, and

d) about 50% reduction in length of the brass coating plant.

The present invention thus also relates to a steel wire coated with a layer of brass obtained by means of a process comprising the stages of:

a) acid pickling,

b) copper plating,

c) zinc plating, and

d) thermal diffusion

characterized in that

stage b) is carried out according to the process of acidic copper plating according to the present invention.

Preferably, the steel wire according to the present invention has also undergone a stage of drawing.

Another object of the present invention is a metallic cord, characterized in that it has at least one steel wire coated with a layer of brass and drawn, obtained according to a process comprising a stage of acidic copper plating according to the present invention.

A further object of the present invention relates to an article of a vulcanized elastomeric material comprising a metallic reinforcing structure, characterized in that said metallic structure includes at least one steel wire coated with a layer of brass obtained by a process that includes a stage of acidic copper plating according to the present invention.

The following examples will serve to illustrate the invention, but without limiting it.

### EXAMPLE 1

### Stage A- acidic pickling according to the prior art

A steel wire with 0.7-0.9% carbon content and diameter of 1.40 mm has undergone chemical pickling in the following conditions:

| | |
|---|---|
| bath composition: | sulphuric acid 300 g/l |
| pH: | 0 |
| temperature: | 50° C. |
| cathode current density: | 60 A/dm² |
| dwell time in the bath: | 10 seconds |

During passage through the bath, the polarity of the wire was varied so that it was cathodic initially, then anodic, cathodic, anodic and, finally, cathodic again.

In the cathodic stage, hydrogen is discharged on the wire, whereas in the anodic stage there is discharge of oxygen, thus dissolving any oxides and surface impurities.

### Stage B- acidic copper plating according to the present invention

The wire from the preceding Stage A was coated with a 1.19 μm layer of copper according to the present invention in the following conditions:

| | | |
|---|---|---|
| bath composition: | copper sulphate | 215 g/l |
| | pentahydrate | |
| | sulphuric acid | 30 g/l |
| | thiourea | 300 mg/l (3.94 mM) |
| | glycine | 340 mg/l (4.53 mM) |
| pH: | 2 | |
| temperature: | 40° C. | |
| current strength: | 56 A | |
| cathode current density: | 33 A/dm² | |
| dwell time in the bath: | 10 seconds | |

### Stage C- zinc plating according to the prior art

A 5 μm layer of zinc was deposited in the following conditions on the wire obtained in the preceding Stage B:

| | | |
|---|---|---|
| bath composition: | zinc sulphate heptahydrate | 370 g/l |
| | aluminium sulphate decaheptahydrate | 30 g/l |
| | sulphuric acid at 40% w/v | 2.5 g/l |
| pH: | 3 | |
| temperature: | room temperature | |
| current strength: | 25 A | |
| cathode current density: | 22 A/dm² | |
| dwell time in the bath: | 5 seconds | |

### Stage D- thermal diffusion according to the prior art

The wire from the preceding Stage C was heated by the Joule effect to 475° C. for 5 seconds. This resulted in a 1.76 μm layer (1.19 Cu +0.57 Zn) of brass, of alpha crystalline phase, cubic, face-centred.

### Stage E- phosphoric pickling according to the prior art

The brass-coated wire obtained in Stage D was treated with a solution of dilute phosphoric acid (3% w/v) for 3 seconds to remove superficial zinc oxide and to provide a thin layer of phosphates to improve the drawability of the wire.

### Stage F- drawing

The wire obtained in Stage E was drawn so as to obtain a wire with a diameter of 0.25 mm, coated with a 0.29 μm layer of brass. No problems were encountered during drawing, and the loss of brass was found to be 10.7%, in line with the usual values.

### Stage G- stranding

A cord 2+2×0.25 was produced with the wire obtained from Stage F. No problems were encountered in this stage either.

### COMPARATIVE EXAMPLE 1

A wire was produced for comparison by the process of the Stages A to D of the preceding Example 1, except that Stage B according to the invention was replaced by the traditional Stages B′ and B″ in succession of basic and acidic copper plating respectively.

### Stage B′- copper plating in a basic bath according to the prior art

A layer of copper of about 0.5 μm was deposited in the following conditions in a basic bath on a steel wire identical to that described in

Stage A of Example 1, which had previously undergone acidic pickling as described in Stage A of the aforementioned Example 1:

| | | |
|---|---|---|
| bath composition: | copper pyrophosphate trihydrate | 100 g/l |
| | potassium pyrophosphate | 400 g/l |
| pH: | 8.5 | |
| temperature: | 50° C. | |
| current strength: | 25 A | |
| cathode current density: | 10 A/dm² | |
| dwell time in the bath: | 14 seconds | |

### Stage B″- copper plating in an acidic bath according to the prior art

About 0.7 μm thick second layer of copper was deposited in an acidic bath in the following conditions, on a wire obtained in the preceding Stage B′:

| | | |
|---|---|---|
| bath composition: | copper sulphate pentahydrate | 215 g/l |
| pH: | 0.8 | |
| temperature: | 40° C. | |
| current strength: | 30 A | |
| cathode current density: | 36 A/dm² | |
| dwell time in the bath: | 5 seconds | |

The wire was then treated as described in Stages C and D of the previous Example 1 and the brass-coated steel wire thus obtained was compared with that obtained at the end of Stage D of Example 1.

The results of the comparison are summarized in Table I below.

TABLE I

| | Brass | |
|---|---|---|
| Characteristics | Comparative Example 1 | Example 1 |
| Composition of brass | Cu = 64-67 wt. % | Cu = 64-67 wt. % |
| Gradient of copper | about 5-10% | about 5-10% |
| concentration in the brass | | |
| along the profile | | |
| Length of the side of the | 3.68-3.69 Å | 3.67 Å |
| cubic cell of α brass | | |
| Diameter of brass | 100-350 Å | 267 Å |
| crystallites (X-ray | | |
| diffraction) | | |
| Components resulting | Adsorbed phosphorus; | / |
| from copper plating in | hydroxides to basic salts | |
| an alkaline bath | of copper | |

Table I shows that the layer of copper deposited on the steel wire during acidic copper plating according to the present invention (Stage B in Example 1) forms, during the stage of thermal diffusion, a brass that has the same metallographic characteristics as that obtained according to the prior art but offers the advantage that it is free from all the impurities that are present in the layer of brass obtained according to the prior art and that originate from copper plating in an alkaline bath (Stage B′ of Comparative Example 1).

### COMPARATIVE EXAMPLE 2

The wire from Stage D of the preceding Comparative Example 1 had undergone the treatments described in Stages E to G of the previous Example 1.

The cord thus obtained was compared with that obtained at the end of Stage G of the previous Example 1, both with regard to corrosion resistance, and with regard to adhesion to an elastomeric compound.

In particular, the corrosion tests were carried out by immersing the cord in an aqueous solution of NaCl at 5% (w/w) at room temperature and measuring the time required for the formation of surface rust. The results of said tests are shown in Table II below.

TABLE II

| | | Time for | Time for |
|---|---|---|---|
| | Time to | formation of rust | formation of rust |
| | appearance of | on 20% of the | on 50% of the |
| Cord | rust (minutes) | surface (minutes) | surface (minutes) |
| Example 1 | 50 | 180 | 360 |
| Comparative | 40 | 120 | 320 |
| Example 2 | | | |

Table II shows that the layer of copper deposited on the steel wire during acidic copper plating according to the present invention (Stage B of Example 1) forms, in the subsequent Stages from C to G, a covering of brass that offers better corrosion resistance than that which is obtained when the layer of copper is deposited according to the prior art (Stages B′ and B′ of Comparative Example 1).

In their turn, the tests of adhesion to the elastomeric matrix showed that there are no significant differences between the cord obtained according to the invention and that obtained according to the prior art.

### EXAMPLE 2 AND COMPARATIVE EXAMPLES 3 AND 4

Three samples of steel wire with 0.7-0.9% carbon content and with diameter of 1.40 mm, which had previously undergone chemical pickling according to Stage A of Example 1, were coated with a 1.10 μm layer of copper in the following conditions:

| | | |
|---|---|---|
| bath composition: | copper sulphate pentahydrate | 215 g/l |
| | sulphuric acid | 30 g/l |
| pH: | 2 | |
| temperature: | 40° C. | |
| current strength: | 56 A | |
| cathode current density: | 35 A/dm² | |
| dwell time in the bath: | 10 seconds | |

In addition, the respective copper plating baths also comprised:

a) 300 mg/l (3.94 mM) of thiourea and 300 mg/l (4.00 mM) of glycine (Example 2 according to the present invention);

b) 50 mg/l (0.66 mM) of thiourea and 50 mg/l (0.67 mM) of glycine (Comparative Example 3);

c) 100 mg/l (1.31 mM) of thiourea and 100 mg/l (1.33 mM) of glycine (Comparative Example 4).

The three wire samples had then undergone Stages C, D, E and F as described in Example 1.

The weight loss of brass during drawing (Stage D) was taken as an index of adherence of the layer of brass to the steel wire. The difference in weight of the brass coating before and after passing through the drawing dies was determined by atomic absorption spectrophotometry.

The results are shown in Table III below.

TABLE III

| | Loss of brass |
|---|---|
| Sample | (percentage by weight) |
| Example 2 according to the invention | 12.6 |
| Comparative Example 3 | 45.7 |
| Comparative Example 4 | 36.5 |

Table III shows that the loss of brass is excessive in the case of Comparative Examples 3 and 4 since the quantities of thiourea and of glycine in the respective copper plating baths were not sufficient to counteract the phenomenon of cementation.

### COMPARATIVE EXAMPLE 5

Stage B of Example 1 was repeated using 640 mg/l (8.41 mM) of thiourea and 700 mg/l (9.32 mM) of glycine. No substantial improvement was observed relative to Stage B of Example 1.

What is claimed is:

1. An electrolytic process for depositing copper on a steel wire in which said wire travels through an acidic electrolytic bath comprising an aqueous solution of Cu²⁺ ions in the form of a salt of an acid, a direct electric current passing through said solution between at least one anode and said wire acting as cathode, said bath comprising from 1.9 to 6 mM/l of a thiourea and from 1.9 to 6 mM/l of an amino acid.

2. The process according to claim 1, in which said thiourea has the following general formula: 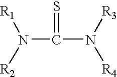
where
R₁ is hydrogen or methyl; and
R₂, R₃ and R₄, the same or different, are hydrogen, alkyl with 1-4 carbon atoms, alkenyl with 2-4 carbon atoms, alkoxy with 1-3 carbon atoms, alkanoyl with 2-4 carbon atoms or phenyl.

3. Process The process according to claim 2, in which said thiourea is selected from the group comprising: thiourea, monophenyl thiourea, monoallyl thiourea and monoacetyl thiourea.

4. The process according to claim 1, in which the amino acid is selected from the group comprising: glycine, cysteine, alanine and methionine.

5. The process according to claim 1, in which the copper salt is a sulphate.

6. The process according to claim 1, in which said acidic electrolytic bath contains from 47 to 62 g/l, of Cu²⁺.

7. The process according to claim 1, in which the there is a cathode current density from 20 to 40 A/dm².

8. The process according to claim 1, in which the temperature of said acidic electrolytic bath is from 30 to 50° C.

9. The process according to claim 1, in which the pH of said acidic electrolytic bath is from 1 to 3.

10. A steel wire coated with a layer of brass obtained by a process comprising the steps of:
a) acid pickling,
b) copper plating,
c) zinc plating, and
d) thermal diffusions,
wherein step b) comprises depositing copper on the steel wire traveling through an acidic electrolytic bath comprising an aqueous solution of Cu²⁺ ions in the form of a salt of an acid, a direct electric current passing through said solution between at least one anode and said wire acting as cathode, said bath comprising from 1.9 to 6 mM/l of a thiourea and from 1.9 to 6 mM/l of an amino acid.

11. The steel wire according to claim 10, further comprising a step of drawing.

12. A metallic cord, comprising at least one steel wire according to claim 10.

13. An article made of a vulcanized elastomeric material comprising a metallic reinforcing structure, said metallic reinforcing structure comprising at least one steel wire according to claim 10.

14. An article made of a vulcanized elastomeric material comprising a metallic reinforcing structure, said metallic reinforcing structure comprising at least one metallic cord according to claim 12.

15. The steel wire according to claim 10, wherein the thiourea in the bath of step b) has the following general formula: 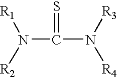
where
R₁ is hydrogen or methyl; and
R₂, R₃ and R₄, the same or different, are hydrogen, alkyl with 1-4 carbon atoms, alkenyl with 2-4 carbon atoms, alkoxy with 1-3 carbon atoms, alkanoyl with 2-4 carbon atoms or phenyl.

16. The steel wire according to claim 15, wherein the thiourea in the bath of step b) is selected from the group comprising: thiourea, monophenyl thiourea, monoallyl thiourea and monoacetyl thiourea.

17. The steel wire according to claim 10, wherein the amino acid in the bath of step b) is selected from the group comprising: glycine, cysteine, alanine and methionine.

18. The steel wire according to claim 10, wherein the copper salt in the bath of step b) is a sulphate.

19. The steel wire according to claim 10, wherein the acidic electrolytic bath of step b) contains from 47 to 62 g/l, of Cu²⁺.

20. The steel wire according to claim 10, wherein there is a cathode current density from 20 to 40 A/dm² in the bath of step b).

21. The steel wire according to claim 10, wherein the temperature of the acidic electrolytic bath in step b) is from 30 to 50° C.

22. The steel wire according to claim 10, wherein the pH of the acidic electrolytic bath in step b) is from 1 to 3.
